(19) United States
(12) Patent Application Publication
(10) Pub. No.: US 2025/0088473 A1
(43) Pub. Date: Mar. 13, 2025

(54) A METHOD AND ELECTRONIC DEVICE FOR MESSAGING

(71) Applicant: 8Seats Group Pty Ltd, Vaucluse, New South Wales (AU)

(72) Inventor: Iain McDonald, Vaucluse, New South Wales (AU)

(21) Appl. No.: 18/723,745

(22) PCT Filed: Dec. 23, 2022
(86) PCT No.: PCT/AU2022/051580

§ 371 Date: Jun. 26, 2024

(30) Foreign Application Priority Data
Dec. 23, 2021 (AU) 2021904225

(51) Int. Cl. H04L 51/043; G06T 11/00

(52) U.S. Cl. CPC H04L 51/043; G06T 11/00; G06T 2200/24

(57) ABSTRACT

A method, electronic device and computer program product for messaging is disclosed, comprising: at a computer system, wherein the computer system is capable of communicating with a display: receiving a request to display a group of message participants, the message participants being at least two participants; in response to receiving the request to display a group of message participants, displaying a participant representation for each participant or subgroups of participants in a participant interface area; enabling each participant representation to have one of a plurality of selectable states including one or more active states and one or more inactive states; displaying, in a message interface area, messages associated with each participant or groups of participants that are in a selected active state.

### TECHNICAL FIELD

The invention relates generally to a method and electronic device for messaging, and, in particular, to a method and electronic device which provides selectable states of a group of participants in a message conversation.

### BACKGROUND OF INVENTION

Messaging, being the ability for users of a particular application or device to send content to one or more other users, has developed as an important feature in business, social media and other fields. Moreover, the content of messages has developed from the “short messaging service”, or text messages, native to mobile cellular communication, to, essentially, any distributable content, such as photos, videos and files.

Some applications are targeted at mass distribution to any person interested, such as Twitter® and Instagram®, and some are intended to be used with existing contacts, such as WhatsApp®. Increasingly, business orientated applications, such as Slack® and Microsoft Teams®, are centred around messaging between people associated with a particular workstream or project.

All of these existing applications allow participants to interact in a single threaded conversation, or receive a single feed, where all participants see each other's content, or at least the content of account being followed. For the applications directed more to messaging between users, in order to message a different selection of people within the same group, a new group must be created. For the applications directed at mass distribution, it is generally not possible to send a message to a particular subgroup associated with the account being followed.

A user's interaction with application is an important factor in delivering an efficient and usable experience. In particular, increasing the rate (or decreasing the time) it takes to perform a particular task allows a user to interact more quickly with the intended audience.

It is desirable to mitigate or ameliorate one or more of the foregoing issues or to provide a useful alternative.

### SUMMARY OF INVENTION

According to a first aspect of the present disclosure there is provided a method for messaging, comprising: at a computer system, wherein the computer system is capable of communicating with a display: receiving a request to display one or more groups of message participants, the message participants being at least two participants; in response to receiving the request to display the one or more groups of message participants, displaying a participant representation for each participant in a participant interface area; enabling each participant representation to have one of a plurality of selectable states including one or more active states and one or more inactive states; displaying, in a message interface area, messages associated with the messaging participants that are in an active state.

Another aspect of the present invention provides a method for messaging, comprising: at a computer system, wherein the computer system is capable of communicating with a display:
receiving a request to display a group of message participants, the message participants being at least two participants or subgroups of participants;
in response to receiving the request to display a group of message participants, displaying a participant representation for each participant or subgroups of participants in a participant interface area
enabling each participant representation to have one of a plurality of selectable states including one or more active states and one or more inactive states
displaying, in a message interface area, messages associated with each participant or groups of participants that are in a selected active state.

Another aspect of the present invention provides an electronic device for messaging, comprising: a computer system, wherein the computer is capable of communicating with a display:
the computer system operating to:
   display a group of message participants, the message participants being at least two participants or subgroups of participants, by displaying a participant representation for each participant or subgroups of participants in a participant interface area;
   enable each participant representation to have one of a plurality of selectable states including one or more active states and one or more inactive states
   display, in a message interface area, messages associated with each participant representation that are in a selected active state.

Another of the present invention provides a computer program product for messaging configured to perform a method, comprising: at a computer system, wherein the computer system is capable of communicating with a display:
receiving a request to display a group of message participants, the message participants being at least two participants or subgroups of participants;
in response to receiving the request to display a group of message participants, displaying a participant representation for each participant or subgroups of participants in a participant interface area
enabling each participant representation to have one of a plurality of selectable states including one or more active states and one or more inactive states
   displaying, in a message interface area, messages associated with each participant or groups of participants that are in a selected active state.

In some embodiments, the computer system includes data storage and is operable to store in the data storage each combination of participant representations having active states and/or messages associated with those active states.

In some embodiments, the group of message participants is displayed in a participant interface area of the display.

In some embodiments, each participant representation is displayed in the form of an image and/or a label.

In some embodiments, for each participant representation the image and/or label varies according to the selected state of the participant representation.

In some embodiments, each participant representation can represent a message participant or a further subgroup of message participants.

In the above manner, a participant representation can represent an entire further group of participants and, indeed, groups of participants can be nested. An analogy to this might be one group of participants being at a table, a second group of participants representing a room, which includes the table, and other tables of participants, and a third group of participants which includes a conference, having the room and other rooms of the conference as participant representations.

In some embodiments, the computer system is operable to display messages associated with participant representations having the relevant active state. In some embodiments, the messages are displayed in a message interface area of the display. In some embodiments, the participant interface area and message interface area do not overlap. In some embodiments, the participant interface area is located above the message interface area when viewed in a normal orientation. In some embodiments, the participant interface area is simultaneously displayed with the message interface area.

In some embodiments, the computer system is operable to receive a request to display messages associated with a plurality of participants or subgroups of participants in a predefined or stored selected state, in response to receiving the request to display messages associated with a plurality of participants or subgroups of participants, displaying the participant representation for the plurality of participants or subgroups of participants in the predefined or stored selected state and displaying the messages associated with the plurality of participants or subgroups of participants which have an active state.

In some embodiments, the request to display messages is in the form of scrolling between a plurality of stored states of the plurality of participants or subgroups of participants.

In some embodiments, the computer system is operable to receive a request to select a different state of a participant representation. In some embodiments, in response to receiving the request to select a different state of a participant representation, the computer system displays the participant representation in the selected state and the messages associated with each participant representation that are in a selected active state.

In some embodiments, the computer system comprises an input device. A non-exhaustive list of appropriate input devices comprises: a touch screen; a keyboard; a pointing device (such as a mouse or trackpad), a microphone (voice control) or an eye tracking system.

In some embodiments, the request to display messages comprises a predefined user input, particularly, a swipe gesture (such as for touch screen devices or other input which responds to a gesture), a selection of a predefined area of the display (such as a “next” arrow being clicked by a mouse pointer), a keyboard input (such as pressing the left or right arrow).

In some embodiments, the computer system is operable to enable a message to be composed in the device and sent to each participant or groups of participants that are in the selected active state.

In some embodiments, the plurality of selectable states includes a public inactive state which allows participants in that public inactive state to view at least one message between other participants of the group of message participants. This inactive state is equivalent to a person being allowed to overhear a conversation in a room.

In some embodiments, the public inactive state is only enabled or is enabled to have when participants in an active state enable a public mode. For example, by selecting a predefined user input, such as a “public” button.

In some embodiments, participants which are in the public inactive state are enabled to compose messages to the respective participants of the group which are in an active state.

In some embodiments, the method for messaging further comprises: receiving a request to set one or more message participants into at least one inactive state of the one or more inactive states; in response to receiving the request to set one or more message participants into the at least one inactive state: setting corresponding states of the one or more message participants or groups of participants into the at least one inactive state; displaying representations of both the one or more participants with the at least one inactive state and other participants with the one or more active states; and displaying, in the message interface area, the messages associated with each participant or groups of participants that are in the one or more active states, without displaying messages associated with the one or more participants with the at least one inactive state.

In some embodiments, the messages associated with each message participant with the one or more active states is displayed in the message interface area substantially simultaneously with setting the one or more message participants into the at least one inactive state.

In some embodiments, the method for messaging further comprises: displaying a converged message conversation including messages of multiple conversations from corresponding groups and/or subgroups, wherein the corresponding groups and/or subgroups include the same message participants.

In some embodiments, the method for messaging further comprises: displaying a consolidated view that shows messages of consolidated conversations from a plurality of groups and/or subgroups. In some embodiments, displaying the messages of the conversations from the plurality of groups and/or subgroups as the consolidated view is in a chronology order. In some embodiments, the method for messaging further comprises marking and/or labelling the messages from the plurality of groups and/or subgroups in the consolidated view to indicate which group or subgroup that a corresponding message is originated from. In some embodiments, the method for messaging further comprises receiving a request to reply to at least one message of at least one conversation of the conversations from the plurality of groups and/or subgroups in the consolidated view.

In some embodiment, the method for messaging further comprises configuring at least one status and associated functionality of a message with respect to relevant participants, subgroups and/or groups. In some embodiments, the at least one status is related to portability of the message with respect to the relevant participant(s), subgroup(s) and/or group(s). In some embodiments, the at least one status includes a unportable status and the associated functionality is preventing sending of the message to the relevant participant(s), subgroup(s) and/or group(s). In some embodiments, the at least one status includes a portable status and the associated functionality is allowing sending of the message to the relevant participant(s), subgroups and/or group(s). In some embodiments, the method for messaging further comprises determining the at least one status of the message based on a user input. In some embodiments, the method for messaging further comprises determining the at least one status of the message based on one or more predefined rules with respect to contents of the message and/or the relevant participants, subgroups and/or groups. In some embodiments, the method for messaging further comprises determining the at least one status of the message based on machine learning techniques with respect to contents of the message and/or the relevant participants, subgroups and/or groups. In some embodiments, the method for messaging further comprises changing a state of at least one participant of the relevant participants, subgroups and/or groups.

In some embodiments, the method for messaging further comprises: adding one or more participants into a conversation associated with the messages; and displaying one or more messages of the messages to the one or more added participants based on portability of each of the one or more messages. In some embodiments, the method for messaging further comprises determining the portability based on a user input. In some embodiments, the method for messaging further comprises determining the portability based on one or more predefined rules with respect to contents of each message and/or the one or more added participants. In some embodiments, the method for messaging further comprises determining the portability based on machine learning techniques with respect to contents of each message and/or the one or more added participants.

In some embodiments, the messages include one or more applications, wherein at least one characteristic of the one or more applications is adaptable to a state of participants associated with the messages.

In some embodiments, the method for messaging further comprises exchanging at least one of the messages with another messaging platform, wherein the another messaging platform implement a different method for messaging to the method of at least one of the preceding claims.

According to another aspect of the present disclosure there is provided an electronic device comprising: a computer system, wherein the computer is capable of communicating with a display and the computer system operating according to one or more of the methods described above.

According to another aspect of the present disclosure there is provided a computer program product configured to perform one or more of the methods described above at a computer system, wherein the computer system is capable of communicating with a display.

### Definitions

### Messaging

Messaging, in the context of the specification, is the ability for a user of a particular application or device to send content to one or more content receivers. The content receivers may have provided the user, directly or indirectly, with their contact information, such as a phone number, or they may have subscribed or followed an account which the user has the credentials to send content from. Messages are those sent and received by a user and, in general, will be relevant to the user and the other intended recipients of the message. Multiple messages for the same group of recipients are typically referred to as a message stream and are, usually, ordered chronologically.

### Content

Content is any information or electronic package that is distributable to content receivers. For example, content can be, amongst other things, one or more of the following: text; images; audio, video (more than one image, including GIFs); files; or applications. Devices often include applications which are, commonly, known as “messaging applications”. Accordingly, content provided in such an application is often referred to as a message or messages. For this reason, content in this specification is interchangeable with message.

### Electronic Device

Embodiments of electronic devices, user interfaces (UI) for such devices, and associated processes for using such devices are described. In some embodiments, the device is a portable communications device, such as a mobile cellular telephone, that also provides other methods of communication, such as WiFi, Bluetooth and RFID. Such devices also commonly have many sensors, such as, touch screens, GPS location, gyroscopic motion detection, compasses, to name a few examples. These devices also allow for a multitude of applications, or apps, to be installed for many purposes, such as maps, music playing and messaging. Example electronic devices include, without limitation, the Apple® iPhone®, Samsung® Galaxy® or Google® Pixel®. Furthermore, other portable electronic devices include the likes of smart watches and other electronic wearables.

In other embodiments, the electronic devices are personal computers, such as laptops or tablet computers. In some embodiments, the electronic device is not portable, such as a desktop computer. However, all electronic devices capable of messaging are within one or more embodiments.

### BRIEF DESCRIPTION OF DRAWINGS

Embodiments of the invention will now be described with reference to the accompanying drawings. It is to be understood that the embodiments are given by way of illustration only and the invention is not limited by this illustration. In the drawings:

FIG. 1 shows an electronic device according to some embodiments;

FIG. 2 shows a block diagram of an electronic device according to some embodiments;

FIGS. 3A, 3B and 3C show an electronic device comprising user interaction with a participant representation and results display of messages;

FIG. 4 shows an electronic device in which some participant representations have an alternative inactive state;

FIG. 5 shows a representation of the complexity of messaging conversations available with the electronic device;

FIG. 6 shows an electronic device comprising a user interaction to switch between messaging conversations;

FIG. 7 shows an electronic device where individual participant representation represents a group of participants;

FIG. 8 shows an electronic device where a group participant representation is selected into a state edit mode;

FIG. 9 shows an electronic device where the same participants across multiple group chats or subgroup chats are provided with converged message conversations;

FIG. 10 shows an electronic device where a user is provided with consolidated thread views from different groups and/or subgroups;

FIG. 11 shows an electronic device with a first message portability configurations;

FIG. 12 shows an electronic device with a second message portability configurations; and

FIG. 13 shows an electronic device where a user is provided with one or more applications within a conversation, wherein at least one characteristic of the one or more applications is dynamically adaptable to the presence of participants of the conversation.

### DETAILED DESCRIPTION

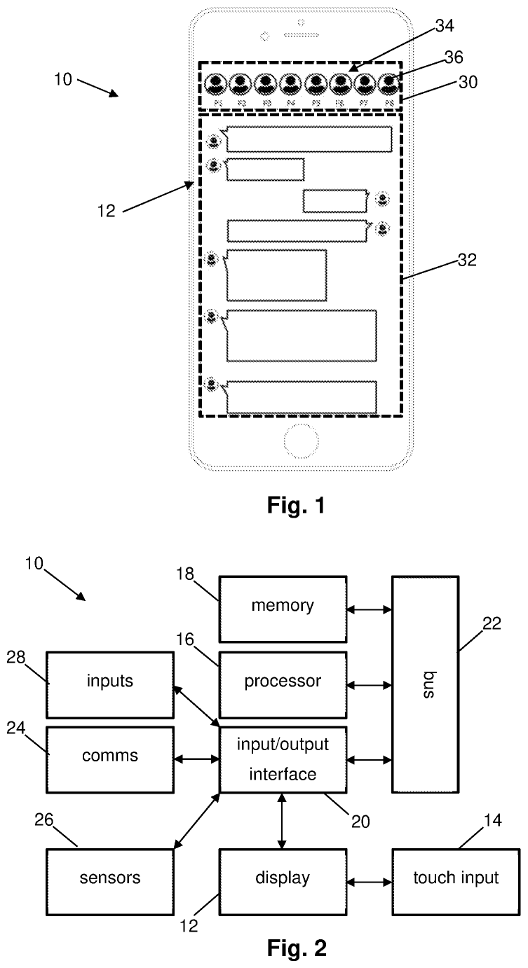

Referring to FIG. 1 and FIG. 2, an electronic device 10, being one form of a computer system or, at least, containing a computer system, is shown, which in this example is a portable communications device in the form of a “smartphone”. However, it should be appreciated that this example is applicable to any electronic device capable of receiving inputs, sending content/messages and displaying information on a screen.

The device 10 comprises a display 12, which in this example of a smartphone also includes a touch screen input 14, such that a user of the device can interact with the display 12 through touch. In other embodiments, user input may be provided by other well-known elements, such as a keyboard or mouse.

Shown only in FIG. 2, but clearly also present in FIG. 1, is a processor 16, being a central processing unit, or units, if multi-core, memory 18, an input/output interface 20 and a bus 22. The bus 22 facilitates internal communication between the processor 16, memory 18 and input/output interface 20. The input/output interface 20 is operatively coupled to the display 12, and therefore the touch input 14, as well as a communication interface 24, a plurality of sensors 26 and a plurality of inputs 28. The communication interface 24 provides external communication for the device 10 using Wi-Fi, Bluetooth, cellular, RFID/NFC and/or other wired/wireless communication techniques. The plurality of sensors 26 are optional, but include typical sensors that might be found in an electronic device, and particularly a portable electronic device, such as a GPS sensor, gyroscope, accelerometer and light sensor. The plurality of inputs 28 are also optional, but include typical inputs that might be found on an electronic device, and particularly a portable electronic device, such as buttons (on/off, mute, volume, multi-function) and a microphone.

Shown only in FIG. 1, is the display 12, which in a particular mode of operation has a participant interface area 30 and a messaging interface area 32. Within the participant interface area 30 are a group of participants 34, which have been pre-defined. For example, the participants could be a group of friends, family members or members of a project team. In this example, a participant representation 36 for each of the individual participants is provided and below each participant representation is a label, in this case P1 to P8, which would typically be the first name of a participant. In some embodiments, the participant representation 36 includes, or is, an image, such as a picture of the relevant participant.

The messaging interface area 32 displays messages/content associated with the group of participants 34. In its most simplest form, the display of content corresponds to messages in a message stream, as is common with messaging applications, with the most recent message at, or close to, the bottom of the messaging interface area 32 and progressively older messages above the most recent message. Scrolling the messaging interface area 32, such as by swiping down on the display 12, allows even older messages to be displayed. In this case, all of the participant representations 36 are in an active state and, therefore, the message interface area 32 displays messages which are viewable by all of the group of participants 34.

The content/message can be distributed to intended participants in a number of ways including: through communication to a central server (or servers) for redistribution to the intended participants; by peer to peer communication, where no central servers are used and users of the system send and receive messages until the message is received by the intended participant. In some embodiments, the content/messages are encrypted in a manner which only allows for the intended participants to read the content and, indeed, the communication link itself is also, preferably, encrypted. In some embodiments, the encrypted messages and/or encrypted communication link may be accessible to user(s) with permissions other than the users associated with the encrypted messages and/or encrypted communication link.

It would be understood that a reference to a message in the above description and in other embodiments described herein can include any content.

The states of any participant representation 36 will now be discussed. A user of the electronic device 10 can contribute to the displayed messages by methods known in the art, such as by clicking on a new message icon to bring up a message entry text box, or by scrolling to the bottom of the message stream, where a message entry box can appear. Once a message has been composed a user can request the message to be sent, such as by selecting a send message icon. At this point, the electronic device 10 will cause the message to be transmitted by the communication interface 24 to a network and ultimately to the relevant participants' own electronic devices, of the group of participants. Typical methods to transmit such messages are known in the art but, for example, include transmission to a central server (or network of servers) and distribution of the messages to the relevant participants or by peer-to-peer transmission. In some embodiments, the transmission method is appropriately encrypted such that the messages are only viewable by the intended recipients. Furthermore, in some embodiments, the messages themselves are encrypted. Regardless of encryption, messages associated with a particular state of a participant in a group of participants are stored in the memory 18 of the device 10. Furthermore, the various groups of participants and their participant representations are also stored in the memory 18 of the device 10.

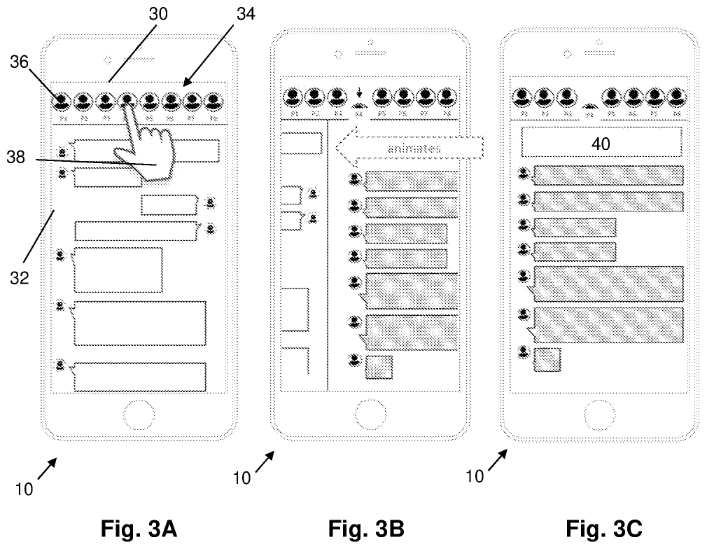

Referring now to FIGS. 3A, 3B and 3C, the same electronic device 10 as described in relation to FIG. 1 and FIG. 2 is shown. Again, the display 12 is displaying the participant interface area 30, having a group of participants 34, and the message interface area 32. The participant representations 36 are enabled to have two or more states and, in particular, at least one active state and at least one inactive state. The provision of further states will be discussed below, but the implementation of further states is equally applicable to the embodiments described in relation to FIGS. 1, 2, 3A, 3B and 3C.

In FIG. 3A, a user 38 selects a particular participant representation 36, being P4 in one example, by touching the relevant participant representation 36. In doing so, the user 38 selects an inactive state of participant representation P4. To provide a suitable user experience, the electronic device 10 changes the view of the participant representation P4 to indicate that that participant is inactive. In this example, the participant representation P4 is partially hidden to indicate that they are in an inactive state in response to the user 38 touching the participant representation P4, as shown in FIG. 3B and FIG. 3C. In this example, simply touching participant representation P4 cycles between an active and an inactive state. However, in other embodiments an alternative mechanism can be provided to select a different state, such as a dropdown box or list. In some embodiments, there may be provided with an efficient mechanism to simultaneously set more than one participant into the same state (e.g. active state or inactive state). In one example, a swipe gesture across relevant participants may set the relevant participants into an active state. In another example, a click on an icon may set all participants into an active state or an inactive state. In some embodiments, there may be provided with an efficient mechanism to initiate a one-to-one (or private) messaging conversation. For example, the one-to-one messaging conversation may be initiated by a press and hold operation on a relevant participant representation.

At the same point, the electronic device 10 provides in the message interface area 32 only messages associated with participants in which their respective participant representation 36 is in an active state. The participant represented by participant representation P4 does not have access to these messages. Again, to provide a suitable user experience, on the participant representation P4 entering an inactive state, the electronic device 10 switches to the new view of messages associated with the participant representations 36 which are active by providing the new view of messages sliding in from one side of the display 12, as shown in FIG. 3B. It would be appreciated by a person skilled in the art that other embodiments may include alternative transition arrangements when participant representation states are changed. For example, there could be no transition arrangement and the new message stream could simply appear or the message stream could appear as part of an alternative image transition sequence.

As shown in FIG. 3C, the message interface area 32 now provides messages which are only available to the participants which have a participant representation that is in an active state. In addition, an information area 40 can be provided, either permanently or temporarily, which, for example, can provide information about the participants which currently have a participant representation which is in an inactive state. The information area 40 could be utilised for display of other information as well, such as the number of messages not shown in the current message interface area 32 or other such information.

In this manner, the electronic device 10 provides a method of quickly and easily creating message conversations with any combination of participants of a group of participants. Prior art applications suffer from the issue of managing message conversations within groups, as a very large number of possible conversations can exist. The electronic device 10 described herein allows the user of the electronic device 10 to rapidly switch and filter between the many possible subgroups associated with a particular group of participants. This functionality is provided with a simple user experience and avoids additional setup, complication and ambiguity to the user.

A particularly important advantage is the removal of the need, compared with the prior art, for the set-up of any groups associated with sub-sets of a group. In this manner, a larger group can be set up, such as a family group or group of friends, and message conversations between sub-sets of that group are immediately available with no further set-up, providing a significant time saving advantage and, in particular, a reduction of steps required to begin a message conversation with multiple sub-sets of the group. The present disclosure may also provide feasible or preferred solutions in the applications where associated display/screen size is relatively small, allowing an efficient interface with efficient change between different message conversations associated with different sub-sets (or subgroups) of the group of participants.

For instance, a participant group of eight participants, with only a single active or inactive state, a total of 255 separate groups are possible, so 255 separate possible message conversations (including groups of single participants). For any specific individual, this means that they could have up to 128 separate groups that they are a part of. To be able to move between each of these messaging conversations in prior art applications, a new subgroup must be created for each possible messaging conversation. As such, the electronic device 10 provides a substantial improvement on the efficiency of managing multiple message conversations in a larger group. The present disclosure allows flexibly adding or changing participant(s) from a group to create one or more subgroups of participants. For example, it does not require the user to go back to the original group of participants or a full participant list for selecting participants for a new subgroup, reducing the steps and time for the user to create one or more subgroups. Message conversations of these embodiments allow more natural conversation dynamics, as it provides for participants to easily drift between wider group conversations and more specific smaller group and individual conversations.

To illustrate the above embodiments in a real world example, a group of friends called “The Book Club” consists of eight members. All eight members require to be able to message each other to discuss the latest book. Seven of the members need to organise a birthday present for the eighth in the group. Prior solutions require two separate groups to be created and to be utilised.

The electronic device as described above only requires the initial group of eight members of the book club to be set up. When one member wants to organise the birthday present for another member, they simply change the participant representation of the relevant member (i.e., the member who is going to have a birthday) to an inactive state and can immediately message the remaining six members of the group.

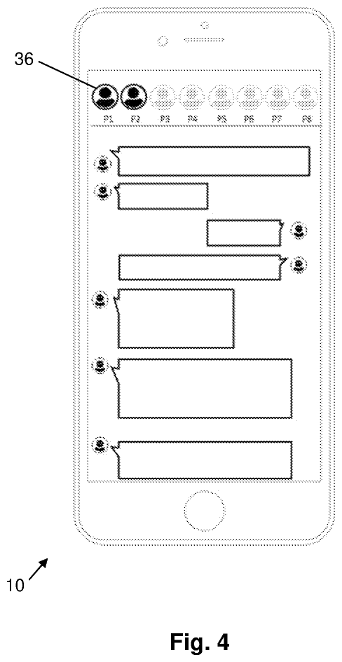

Referring now to FIG. 4, the electronic device 10 of earlier embodiments is shown. In this embodiment, the electronic device 10 demonstrates further functionality by providing participants with additional states possible for their respective participant representation 36. In FIG. 4, participant representations P1 and P2 are in an active state and the respective participants are engaged in a messaging conversation. However, either P1 or P2 has enabled, or in some embodiments both are required to enable, the particular messaging conversation which they are engaged in to be available to the entire group of participants. That is, participants representations P3 to P8 are placed in a public inactive state, denoted in FIG. 4 by the participant representations being “greyed out”. In this mode of messaging, the active messaging conversation is between participants P1 and P2 but that messaging conversation is available to any of participants P3 to P8 and any of participants P3 to P8 can access the messaging conversation and, indeed, join in by adding their own messages to the conversation. The device 10 does not, by default, provide notifications to this conversation group but, for example, could provide an indication that there is an active conversation occurring.

In providing a first “public inactive” functionality to a message conversation between a subgroup of a group of participants, the wider group can view the message conversation, if they wish. An analogy in the real world would be a small subgroup having a conversation at a table and one or more of the remainder of the group around the table choosing to listen in to the conversation without participating. Ultimately, if one or more of the remainder of the group hears something interesting in the conversation, they can choose to join in with that conversation. In this way, the functionality described in these embodiments mirrors more natural conversation dynamics between a particular group of participants.

A real world example in this context is a group of seven friends in which three of the friends wish to discuss ‘cryptocurrencies’. Those three friends do not want to bombard the other four people with potentially unwanted or irrelevant messages on cryptocurrency, but they wish for anyone of the group who is interested to read the messages or join in.

The friends, in this case, already have a group set up with all seven people. The three friends start a private conversation between the three of them by setting the other four to an inactive state but then set the message stream as public to the group. The message stream becomes available to the remaining four friends but they are not necessarily alerted to new messages in the message stream.

Additionally or alternatively, in providing a second “public inactive” functionality to a message conversation between a subgroup of a group of participants, the wider group can view particular messages as selected by one or more participants in the subgroup while the other messages remain private within the subgroup. An analogy in the real world would be a small subgroup having a conversation planning an event and one or more of the remainder of the group awaiting to receive a finalised event plan without participating in planning the event. In this way, the functionality described in this embodiment avoids creating a new group for the subgroup to discuss the event plan which is to be announced after determination and also avoids repeating the messages that are already available in the subgroup conversation.

A real world example in this context is a group of nine project members in which two of the project members are managers and wish to discuss workflow and reward scheme for an associated project. Those two managers do not want the rest of the project members to get involved in the draft discussion stage, but they would like to announce a finalised or an intermediate workflow and reward scheme to the other project members

The project members, in this case, already have a group set up with all nine people. The two managers start a private conversation between the two of them by setting the other seven members to a public inactive state but then select particular messages that they would like to announce as public messages to the rest of the group members. The selected messages become available to the remaining seven project members but they do not have access to the other messages.

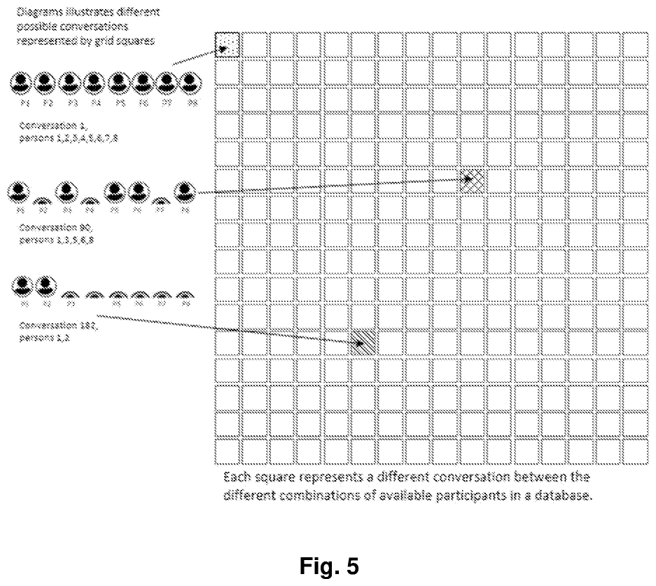

Through providing participants of a group with multiple states, that is, potentially, multiple active states and multiple inactive states, the potential number of messaging conversations becomes very large. Taking, simply, the possible states discussed thus far in the specification, being active, inactive (public) and inactive (private), the number of unique conversations for an eight person group is 509, as represented visually in FIG. 5. It will be understood that the number of unique conversations will be different in other examples with different number of participants in the group and/or different number of states available for the participants. Providing an electronic device and user interface which provide the functionality to achieve this complexity in a manner which is usable is non-trivial. Furthermore, the recognition that message conversations require greater flexibility to approximate natural and dynamic conversations within a group is, again, non-trivial. The electronic device 10 described herein achieves this in a manner which is suitable for all types of electronic devices, from those with limited display sizes, such as smart phones, to more traditional personal computer displays and in all cases, provides substantial efficiency gains for a user, particularly due to the removal of the need to manually create groups of participants for a message conversation and the efficient use of screen real estate to move between message conversations.

In some embodiments, in order to efficiently manage the large number of messaging conversations, the electronic device described herein may intelligently recognise where a message may be sent to a messaging conversation with unintended participant(s), e.g., based on content of the message and the associated participant(s).

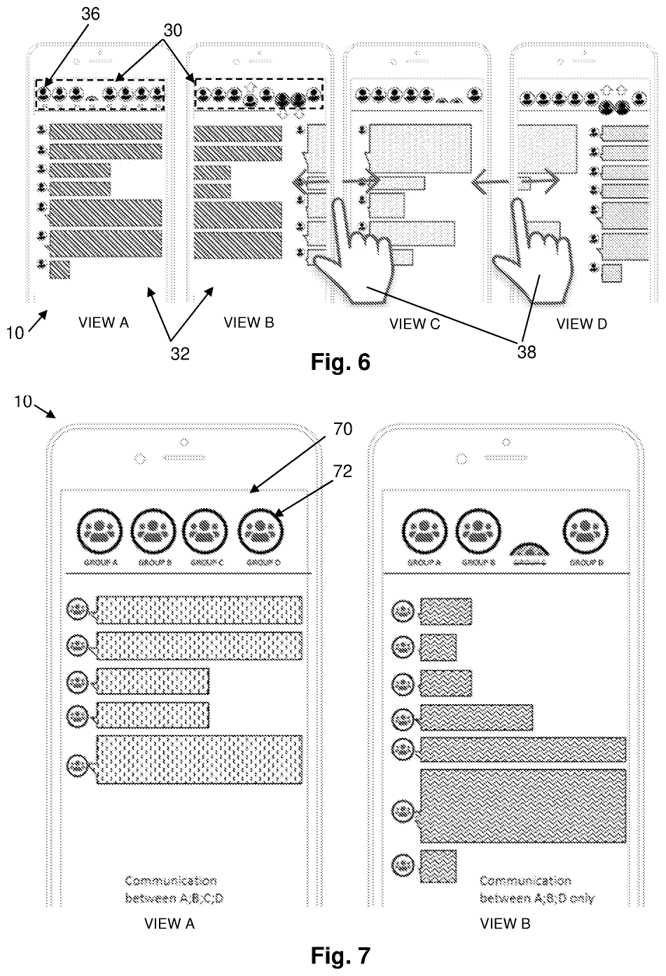

Referring now to FIG. 6, four views A, B, C and D are shown of the electronic device 10 with participant interface area 30 and message interface 32. As described with reference to FIGS. 3A, 3B and 3C above, changing the state of one or more of the participant representations 36 results in messages being displayed in the message interface area 32 appropriate to the relevant state of the participant representations 36. In the simplest embodiment, messages will be displayed relevant to the participant representations 36 which are in an active state.

In an alternative control method, which is provided in addition to the control method described above, the user 38 can provide an input to the electronic device 10 to scroll between available message streams (i.e. a plurality of stored states of the plurality of participants or subgroups of participants). For a touch screen electronic device 10, such as shown in FIG. 6, this input can be in the form of swipe gesture. For non-touch electronic devices, or as an alternative or additional method of control, scroll icons or areas of the screen may be provided and a suitable input means, such as a keyboard or mouse, can select the relevant icon or area to cause scrolling.

In view A of FIG. 6, the message stream of a group of participants 34 is provided were the participant representation P4 is shown in an inactive state so that participant represented by P4 does not have access to this particular message stream. An input is provided in view B in the form of a swipe gesture causing the next message stream to be provided in the message interface area 32, as shown in view C. The message stream of view C has participant representations P6 and P7 in the inactive state, so the corresponding participants do not have access to this message stream. It is also preferable, from a user experience perspective, if the participant representations 36 which are changing state, in this case P4, P6 and P7 during the view change between view A and view C, are provided with an animation as they change between states. In the same manner, the outgoing and incoming message streams can be displayed such that the new message stream appears from a side of the display 12 and the old message stream disappears on the opposite side of the display 12.

View D shows a further input from the user 38 to scroll from the message stream of view C and, as can be seen, participant representations P6 and P7 are shown as changing to an active state. Therefore, all participant representations 36 are active in view D such that the message stream is available to all participants of the group.

Message streams may be organised in chronological order, with the message stream with the most recent messages being displayed earliest in the message stream array. Alternatively, the message streams may be ordered by, for example, order of the first created message in each message stream,

Referring now to FIG. 7, the electronic device 10 now shows a group of participants 70, different to the group of participants 34 referred to earlier. In this case, group participant representations 72 are each to another group of participants, in this case Group A, B, C and D. That is, it is possible for a first group of participants to be a participant in a second group of participants, in a nested manner. Although the group of participants 70 all contain participants which are themselves groups of participants, it is also possible to include single participants alongside participants which are groups of participants.

In the same manner as described in the embodiments above, view A of FIG. 7 shows all group participant representations 72 of the group of participants 70 to be in an active state. As such, the message stream shown in the message interface area 32 contains messages available to all of the group of participants 70. In view B participant representation “GROUP C” is shown in an inactive state and, therefore, the message stream shown in the message interface area 32 contains messages available to participants associated with participant representations “GROUP A”, “GROUP B” and “GROUP D”.

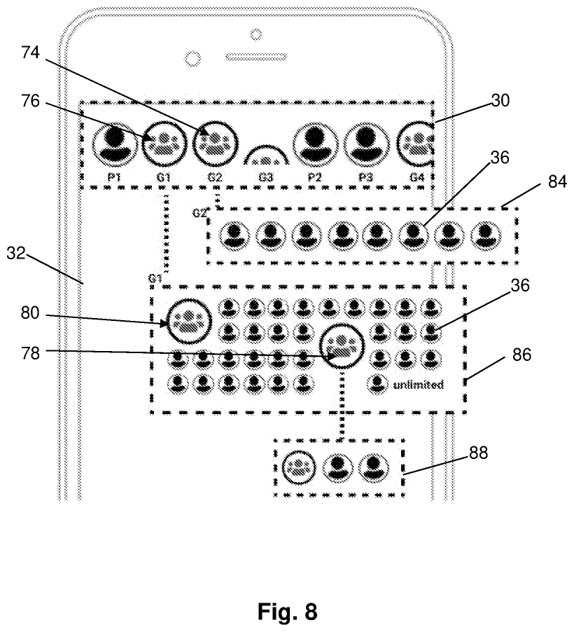

Each group participant representation 72, which each represents a group of participants, can be viewed in a manner which allows manipulation of the state of the participants of that group. As shown in FIG. 8, one example of this embodiment allows a group participant representation 74 in participant interface area 30 to be selected into a state edit mode, where a subgroup participant area 84 is displayed, which in this example overlays message interface area 32. Whilst in this mode, individual participant representations 36 can have their states changed as previously described.

Of course, further embodiments allow for nested group participant representations where a group participant representation is a member of a group participant representation. For example, group participant representation 76 is in a state edit mode where subgroup participant area 86 is displayed. As can be seen, the group represented by group participant representation 76 includes group participant representations 78, 80 and a plurality of participant representations 36. In this example, group participant representation 78 is also in a nested state edit mode as a subgroup participant area 88 is displayed.

In addition, as any group of participants could have a large number of participants, the participant representations 36 (or group participant representations 72) may be scrolled within the participant interface area 30. That is, if all participants cannot be shown in the participant interface area 30, swiping left or right (where a touch screen device is used) allows the participant representations to be scrolled such that their state can be altered as required.

In addition, further embodiments allow for alternative use of screen real estate, such as where the subgroup participant area (e.g., 86) is displayed as a separate view or is not overlaid over content interface area 32 but instead, moves the content interface area 32 further down the screen. In some embodiments, there may be provided with a separate view of all participant representations of a group or subgroup to show a full list of participants and their states. In some examples, for the cases where a large number of participants are associated with a group/subgroup, each participant representation in the full list may have a small size and not operatable for changing states. In these cases, there may be provided with a mechanism to bring up another view with operatable participant representations for change states while the full view of non-operable participant representations is to provide a overview to the user in regards to the participants associated with the group/subgroup and their states.

It would also be appreciated by the person skilled in the art that the ability of changing states may be subject to certain permission level(s) of the associated participants. The permission level(s) associated with each participant may be predefined. For example, the state of a participant that is not part of a leadership subgroup cannot be changed to active in the leadership subgroup.

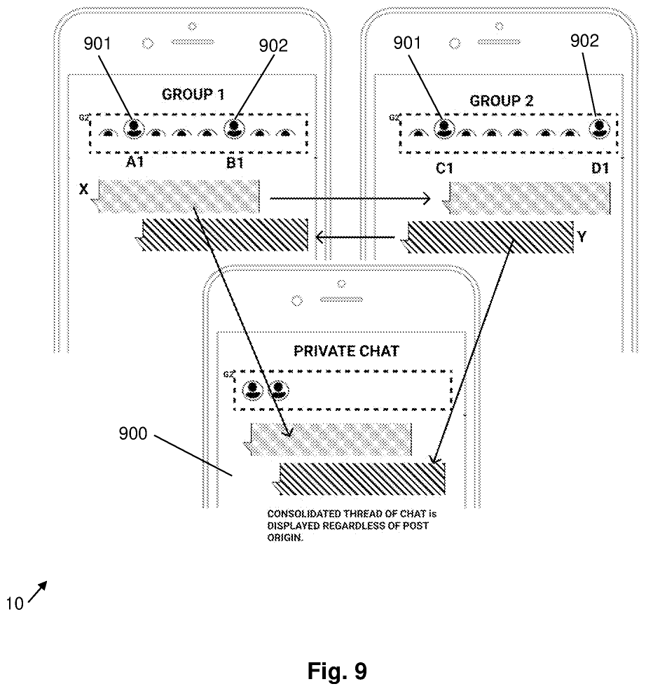

Referring now to FIG. 9, the electronic device 10 of earlier embodiments is shown. In this embodiment, the electronic device 10 demonstrates further functionality by providing the same participants across multiple group chats or subgroup chats with converged message conversations.

In this example, a first person (i.e., participant 901) and a second person (i.e., participant 902) may belong in many different groups together with different people. For example, as shown in FIG. 9, the participant 901 in Group 1 and Group 2 is represented by participant representations A1 and C1, respectively, while the participant 902 in Group 1 and Group 2 is represented by participant representations B1 and D1, respectively. The disclosed system/method allows the conversations to be converged so that the participants 901 and 902 are able to access to the same messages between them no matter what group environments those messages are originated from.

In some embodiments, the messages between the participants 901 and 902 may be marked or noted to indicate which subgroup/environment the particular messages are created in. For example, as shown in FIG. 9, message X and message Y were created in different subgroups or environments/contexts which the same participants 901 and 902 belong in. The electronic device 10 is configured to display a converged message conversation 900 consolidating the messages X and Y, each with a different message representation indicating that message X is from Group 1 while message Y is from Group 2, for the participants 901 and 902.

This functionality takes advantage of the functionality described in the previous embodiments that subgroup(s) can be created without going back to a participant list for selecting each of participants of the subgroup(s) and that messaging conversation(s) corresponding to the created subgroup(s) are spontaneously displayed in response to the change in participants. In this regard, the present disclosure provides additional efficiency or time saving by removing the need for the user to investigate which subgroups/environments that particular messages were generated from, which avoids confusion and displaced messages.

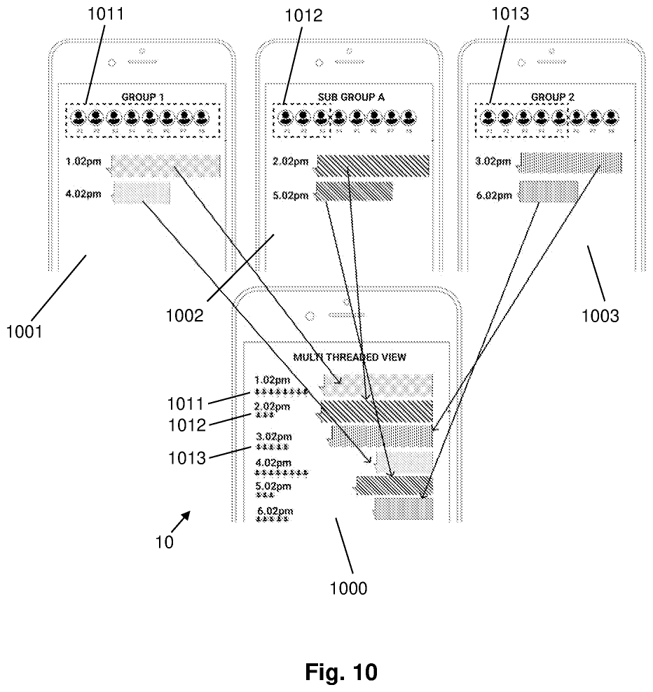

Referring now to FIG. 10, the electronic device 10 of earlier embodiments is shown. In this embodiment, the electronic device 10 demonstrates further functionality by providing a user with consolidated thread views from different groups and/or subgroups.

For example, in order to efficiently manage conversations from a plurality of (e.g., thousands of) possible groups and/or subgroups, a user may request the electronic device 10 to display a single view consolidating conversations from a plurality of groups and/or subgroups into one stream. In this regard, the user is able to read at least one message from each of the conversations from different groups and/or subgroups within a single view and without moving in and out amongst different group and/or subgroup conversations.

FIG. 10 illustrates various exemplary conversations in different groups/subgroups, namely, conversation 1001 in GROUP 1, conversation 1002 in SUB GROUP A and conversation 1003 in GROUP 2. Two messages for each of the conversations 1001, 1002 and 1003 with associated time are shown as an example. FIG. 10 also illustrates an exemplary consolidated conversation 1000 consolidating the messages from the conversations 1001, 1002 and 1003 in a chronology order or based on time entry of a corresponding message.

In some embodiments, only the latest message from conversations of the plurality of groups and/or subgroups are displayed (not shown). In other embodiments, participant representations 1011, 1012 and 1013 of the corresponding groups/subgroups are displayed associated with the corresponding messages in the consolidated conversation 1000. Additionally or alternatively, group names of the corresponding groups/subgroups are displayed associated with the corresponding messages in the consolidated conversation 1000 (not shown). Additionally or alternatively, the messages of the conversations from different groups/subgroups are marked or noted in other appropriate means in the consolidated conversation 1000 to indicate which group/subgroups that the corresponding messages are originated from. The user is also able to respond to a conversation of the corresponding original group/subgroup from the consolidated conversation view. For example, the user may select a particular message and reply to the selected message. In another example, the user may be provided with a scrollable menu (not shown) including group and/or subgroup details (e.g., group/subgroup name(s)) for the user to select for reply.

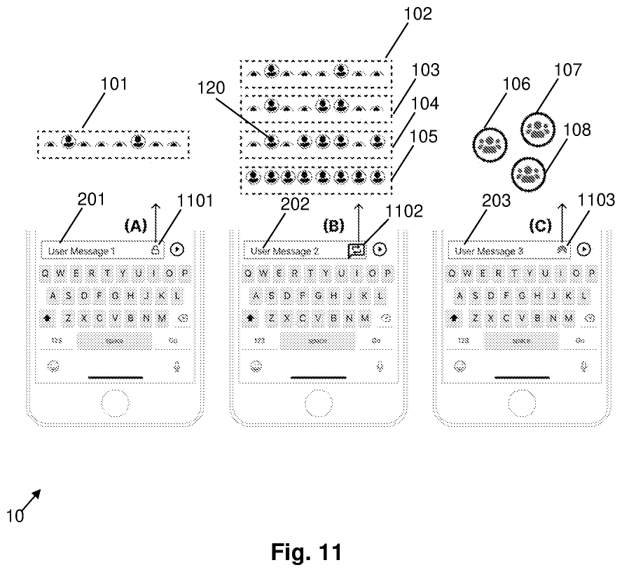

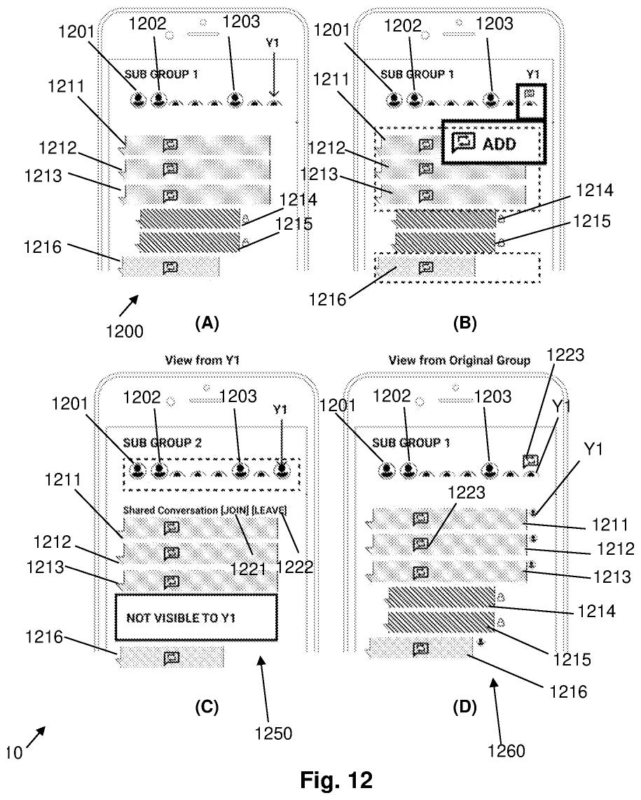

Referring now to FIG. 11, the electronic device 10 of earlier embodiments is shown. In these embodiments, the electronic device 10 demonstrates further functionality by providing a user with first message portability configurations.

In some examples, the message portability configurations allow configuring at least one status and associated functionality of a message with respect to relevant participant(s), subgroup(s) and/or group(s) in a flexibly way. For example, this embodiment configures status and associated functionality associated with the message on a per message basis, allowing the message to be sent/forwarded or locked in accordance with sender's permission and/or in accordance with a permission derived based on conversation participants and/or the message content. That is, the at least one status is related to portability of a message with respect to the relevant participant(s), subgroup(s) and/or group(s). Configuring the at least one status of the message can be done before or after sending the message. In contrast, conventional messaging applications simply have a single send button, which sends messages to predefined participant(s) or group(s).

For example, in FIG. 11 (A), at least one status of a message 201 is an unportable or locking status. That is, the message 201 is locked to a specified subgroup 101. The subgroup 101 may be the group that the message 201 is going to be sent to. The associated unportable or locking functionality of the message 201 is indicated by a first symbol or icon (e.g., a lock icon 1101 close to the message 201). Relevant group(s), subgroup(s) and/or participant(s) (e.g., the subgroup 101 in this example) may be displayed associated with the first icon/symbol indicating the locking functionality. As a result, the message 201 is locked within the subgroup 101 and cannot be sent from the subgroup 101.

In another example, FIG. 11 (B) of the present disclosure illustrates at least one status of a message 202 relating to a portable status. that is, the message 202 can be sent to or moved between nominated participant(s), group(s) and/or subgroup(s) (e.g., subgroup 102, subgroup 103, subgroup 104 and group 105), and/or that participants may be moved in (meaning that the participants are able to receive the message 102) and out (meaning that the participants are not able to receive the message 102), e.g., by the sender or by automatic determination of the electronic device 10, for the message 102. For example, before sending the message 102, for an existing nominated subgroup 104, the sender may simply touch a participant representation 120 to change its state to inactive (i.e., moving the participant represented by 120 out of the subgroup 104) for sending message 102. By inactivating participant represented by 120, a subgroup that is different from the subgroup 104 is created for sending the message 102. That is, the present disclosure allows flexibly and efficiently creating subgroups or changing participants of existing subgroups for a particular message to be sent.

In some embodiments, the nominated participant(s), subgroup(s) and/or group(s) (e.g., subgroup 102, subgroup 103, subgroup 104 and group 105 as illustrated in FIG. 11 (B)) may not include the groups/subgroups/participants that the message 202 is going to be sent to. In this regard, with the portability status of the message 202, the message 202 resides in its current groups/subgroups/participants conversation(s) can only be sent or forwarded to or moved between the nominated participant(s), subgroup(s) and/or group(s). This functionality may be indicated by a second symbol or icon, different from the first symbol or icon for the locking functionality (e.g., a recycle icon 1102 close to the message 202).

In yet another example, FIG. 11 (C) illustrates another portable status of a message 203. That is, the message 203 can be sent to or moved between groups and subgroups 106, 107 and 108 in this example. This functionality may be indicated by a third symbol or icon, different from the first and second symbols/icons (e.g., a broadcast icon 1103 close to the message 203).

The disclosed embodiments provide variable message status indicating associated different functionality for a particular message based on context of the message, content of the message, potential recipients of the message, and/or user selection. Configuring the at least one status of a message can be done before or after sending the message. In addition to the efficiency and flexibility advantages discussed above, this may address the problems of privacy and accidental message sending.

In particular, determination of the message status may be based on message sender's selection/permission. Additionally or alternatively, the message status may be determined or recommended based on one or more pre-determined rules. In particular, where a message appears to meet one or more pre-determined rules, the status of the message is changed to a “locking” status to prevent accidental sending. For example, when a message contains a phone number, this message may be locked to particular participants and/or groups/subgroups including those particular participants. Additionally or alternatively, the message status may be determined or recommended based on artificial intelligence or machine learning techniques. For example, natural language processing techniques may be used to determine or recommend a status of a word/voice-based message. In another example, computer vision techniques may be used to determine or recommend a status of an image/video-based message. For example, where a message appears to be private, determined by the electronic device, the status of this message will be changed to a “locking” status to prevent accidental sending.

Referring now to FIG. 12, the electronic device 10 of earlier embodiments is shown. In this embodiment, the electronic device 10 demonstrates further functionality with second message portability configurations.

In particular, the further functionality with second message portability configurations allows people to move in and out of conversations and allows people to add other people to existing conversations while allowing the newly added people to have access to one or more previous messages in the existing conversations. In contrast, a participant that is newly added to an existing group in conventional messaging applications typically does not have access to the messages existing in the group conversation prior to his/her joining.

A real world example in this context is a group of three friends each represented by a participant representation 1201, 1202 and 1203, respectively, planning to attend an event in a first subgroup (e.g., SUB GROUP 1 as illustrated in FIG. 12 (A)). They initially did not include a fourth friend Y1 in the first subgroup as they thought Y1 is out of town. When they realise the fourth friend Y1 is in town, they would like to include Y1 into their conversation 1200.

In conventional messaging applications, either a new group including four participants 1201, 1202, 1203 and Y1 would need to be created or Y1 would be added to the existing group including participants 1201, 1202 and 1203. In any event, the conventional messaging applications would require some of the messages that participants 1201, 1202 and 1203 have discussed to be copied and pasted or rewritten or forwarded for the newly added participant Y1 to read.

With the improved messaging application in accordance with the present disclosure, the participant Y1 can be included in the conversation 1200 amongst participants 1201, 1202 and 1203 without further setup (e.g., without creating a new group of four participants from scratch) by the methods described in the previous embodiments (e.g., through a touch on the participant representation of Y1 by one of the participants 1201, 1202 and 1203 to change Y1's state to ‘active’), thereby creating a second subgroup (e.g., SUB GROUP 2 as illustrated in FIG. 12 (C)) including the participants 1201, 1202, 1203 and Y1.

In some embodiments, the participant Y1 in the second subgroup may only be able to have access to the messages of the first subgroup which are marked by at least one of the participants 1201, 1202 and 1203 as portable. In the example as illustrated in FIGS. 12 (A) and (B) and (D), messages 1211, 1212, 1213 and 1216 are marked as portable and can be accessed by the newly added participant Y1 in the second subgroup while messages 1214 and 1215 are marked as locked or unportable to the second subgroup which the newly added participant Y1 will not have access to. In some examples, only the messages that are determined to be unportable are selected and/or marked while the rest of the messages in the conversation are automatically determined and/or marked as portable, and vice versa. In some embodiments, the message portability is determined based on user selection. Additionally or alternatively, the message portability is determined by the electronic device 10, e.g., based on the message contents in view of one or more pre-determined rules and/or machine learning techniques.

FIG. 12 (C) illustrates a conversation view 1250 from the newly added participant Y1. As shown, the newly added participant Y1 does not have access to the messages 1214 and 1215 but can see the other messages from the conversation 1200 amongst the participants 1201, 1202 and 1203 that are marked portable. The newly added participant Y1 can choose to join or leave the conversation 1200, e.g., by selecting a ‘JOIN’ icon 1221 or a ‘LEAVE’ icon 1222 as shown in FIG. 12 (C), correspondingly.

FIG. 12 (D) illustrates a conversation view 1260 of a participant (i.e., 1201, 1202 or 1203) from the first subgroup. As shown, one or more participants (e.g., the participant Y1 in this example) which are added to the conversation as in a second subgroup (e.g., SUB GROUP 2 in this example) may be marked using a symbol or an icon (e.g., an ‘ADD’ icon 1223 close to the participant representation Y1). The messages 1211, 1212, 1213 and 1216 that are determined to be portable to the second subgroup including the newly added participant(s) (e.g., the participant Y1) may be marked using the same ‘ADD’ icon 1223. Additionally or alternatively, the messages 1211, 1212, 1213 and 1216 that are determined to be portable to the second subgroup may be marked with the participant representation(s) of the newly added participant(s) (e.g., Y1 in this example), indicating that those messages are accessible by which of the newly added participant(s).

In some examples, the conversation (e.g., 1200) of an original subgroup/group (e.g., SUB GROUP 1) may be permanently migrated to a new subgroup/group (e.g., SUB GROUP 2) so that the conversation (and newly added participant(s) (e.g., Y1) in other examples) is no longer visible between the participants of the original group (e.g., 1201, 1202 and 1203).

It will be appreciated that the disclosed embodiments may provide a new and improved way for sharing conversations with more flexibility and efficiency, for example, without exposing private messages in a different group including different participants (e.g., the second subgroup in the above example) by marking those messages as unportable accordingly, and/or requiring less actions from the user to share conversations/messages with different participants/subgroups/groups. For example, no operations of copy and paste, rewriting and/or forwarding would be required.

It will also be appreciated the above operations in a reverse order can be applied if a participant chooses to leave a conversation. A real world example in this context is a group of four friends discussing a trip, in which one participant becomes unwell and cannot make the trip. The unwell participant is able to remove himself/herself from the conversation, e.g., by clicking a ‘LEAVE’ icon, so he/she does not receive further updates from the conversation. The other three participants may receive a notification or view an indication that the unwell participant has left from the conversation. In one embodiment, the other three participants may view all original messages before the unwell participant leaves the conversation. The messages from the unwell/left participant left in the conversation thread may be marked to indicate that those messages are from the left participant. In another embodiment, the unwell participant may opt to leave her/his messages in place or select the message(s) he/she would like to remove from the conversation. Each of the removed messages may appear to the remaining participants as a deleted message with an indicator that the sender has left the conversation.

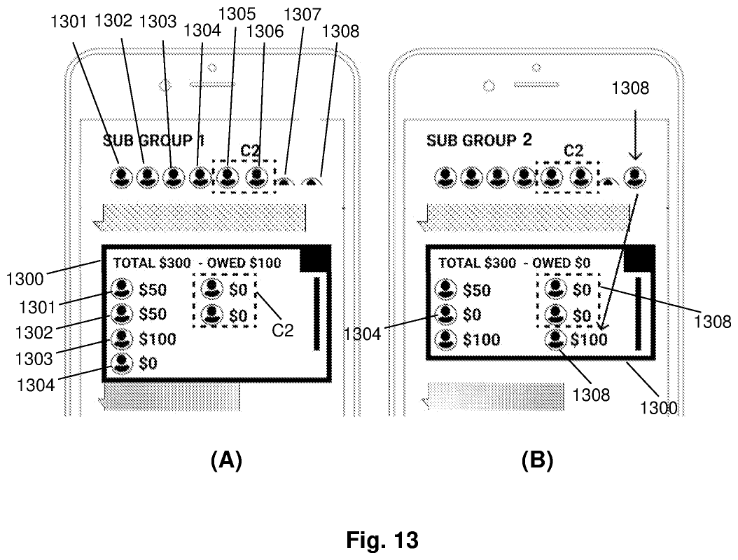

Referring now to FIG. 13, the electronic device 10 of earlier embodiments is shown. In this embodiments, the electronic device 10 demonstrates further functionality by providing a user with one or more applications within a conversation, wherein at least one characteristic of the one or more applications is adaptable to the presence of participants of the conversation. In this regard, the one or more applications can act as one or more interactive messages, which are able to change at least one characteristic based on e.g., who are associated with the one or more applications, and/or who are not associated with the one or more applications but are included in the corresponding conversation, and/or who newly join and/or leave the conversation.

A real world example in this context is a group of eight friends (e.g., GROUP A including participants 1301-1308), in which six of the friends (1301-1306) have attended a restaurant and create a subgroup (e.g., SUB GROUP 1 as illustrated in FIG. 13 (A)) by e.g., inactivating participants 1307 and 1308 in GROUP A. Two of the six participants (1305 and 1306, or collectively C2) have left early and are no longer present. State of each of the participants 1305 and 1306 may be changed to a different state from the states of the participants 1301-1304. For example, each of the participants 1305 and 1306 is in a ‘semi-active’ state while the other four participants 1301-1304 are each with an ‘active’ state. When the bill arrives, one of the six participants (1301-1306) initiates a bill splitting application 1300 within the conversation of SUB GROUP 1 as an interactive message.

For example, the bill splitting application 1300 allows participants in active states to input their bill contributions, displaying the amount (e.g., totals and tips) entered by each active participant. The bill splitting application 1300 may be also configured in a way that the two participants who left early (i.e., C2 that are in semi-active states) can receive the bill splitting application 1300 as a message but do not have access to contribute/pay.

When the participant 1308 that is in GROUP A but inactive in SUB GROUP 1 is invited to pay for the bill, the state of the participant 1308 is changed to ‘active’. Doing so may create a subgroup that is different from SUB GROUP 1, i.e., SUB GROUP 2 including participants 1301-1306 and 1308. With the message portability configurations as described in the above embodiments, the bill splitting application 1300 can be instantly moved to SUB GROUP 2 while being adapted to invoke permissions within the conversation of SUB GROUP 2 to allow the active participants in SUB GROUP 2 to contribute. As a result, the participant 1308 is able to input the amount that he/she would like to contribute to the bill splitting application 1300.

It would be appreciated that the above embodiment may provide one or more applications within a conversation as an interactive message, which is able to adapt based on the context of the subgroups dynamically within the conversation environment. This removes the need of manually setting up parameter(s) within the one or more applications based on the change in context/participants involved as would be otherwise required in conventional applications.

It would also be appreciated that the messaging application/service in accordance with the present disclosure may be featured with interoperability (i.e. ability to exchange messages from other applications/services), e.g., with the assistance of an appropriate application programming interface (API) to facilitate communications between the disclosed messaging application/service and other applications/services. For example, one or more (less than all) participants of a group/subgroup may not have dedicated accounts of the messaging application of the present disclosure but have accounts of other applications/services. With the feature of interoperability, participant(s) having accounts of the messaging application/service in accordance with the present disclosure can communicate with participants having accounts of different applications/services while being provided with the one or more discussed functionality of the messaging application/service in accordance with the present disclosure as above.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

Any reference to or discussion of any document, act or item of knowledge in this specification is included solely for the purpose of providing a context for the present invention. It is not suggested or represented that any of these matters or any combination thereof formed at the priority date part of the common general knowledge, or was known to be relevant to an attempt to solve any problem with which this specification is concerned.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A method for messaging, comprising: at a computer system, wherein the computer system is capable of communicating with a display:
receiving a request to display one or more groups of message participants, the message participants being at least two participants;
in response to receiving the request to display the one or more groups of message participants, displaying a participant representation for each participant in a participant interface area;
enabling each participant representation to have one of a plurality of selectable states including one or more active states and one or more inactive states;
displaying, in a message interface area, the selected state of each participant representation and messages associated with the messaging participants that are in an active state.

2. The method of claim 1 wherein, the computer system includes data storage and is operable to store in the data storage each combination of participant representations having active states and/or messages associated with those active states.

3. The method of claim 1 wherein, each participant representation is displayed in the form of an image and/or a label, and/or the image and/or label varies according to the selected state of the participant representation.

4. (canceled)

5. The method of claim 1, each participant representation can represent a message participant or a further subgroup of message participants.

6. The method of claim 1, the messages are displayed in a message interface area of the display, and/or wherein, the participant interface area and message interface area do not overlap, and/or wherein, the participant interface area is simultaneously displayed with the message interface area.

7. (canceled)

8. (canceled)

9. The method of claim 1 wherein, the computer system is operable to receive a request to display messages associated with a plurality of participants or subgroups of participants in a stored selected state, in response to receiving the request to display messages associated with a plurality of participants or subgroups of participants, displaying the participant representation for the plurality of participants or subgroups of participants in the stored selected state and displaying the messages associated with the plurality of participants or subgroups of participants which have an active state, and/or wherein, the request to display messages is in the form of scrolling between a plurality of stored states of the plurality of participants or subgroups of participants.

10. (canceled)

11. The method of claim 1 wherein, the computer system is operable to receive a request to select a different state of a participant representation, and/or wherein, in response to receiving the request to select a different state of a participant representation, the computer system displays the participant representation in the selected state and the messages associated with each participant representation that are in a selected active state.

12. (canceled)

13. (canceled)

14. (canceled)

15. (canceled)

16. The method of claim 1 wherein, the plurality of selectable states includes a public inactive state which allows participants in that public inactive state to view at least one message between other participants of the group of message participants, and/or wherein, the public inactive state is only enabled when participants in an active state enable or is enabled to have a public mode, and/or wherein, participants which are in the public inactive state are enabled to compose messages to the respective participants of the group which are in an active state.

17. (canceled)

18. (canceled)

19. The method of claim 1, further comprising:
receiving a request to set one or more message participants into at least one inactive state of the one or more inactive states;
in response to receiving the request to set one or more message participants into the at least one inactive state:
setting corresponding states of the one or more message participants or groups of participants into the at least one inactive state;
displaying representations of both the one or more participants with the at least one inactive state and other participants with the one or more active states; and
displaying, in the message interface area, the messages associated with each participant or groups of participants that are in the one or more active states, without displaying messages associated with the one or more participants with the at least one inactive state.

20. The method of claim 19, wherein the messages associated with each message participant with the one or more active states is displayed in the message interface area substantially simultaneously with setting the one or more message participants into the at least one inactive state.

21. The method claim 1, further comprising:
displaying a converged message conversation including messages of multiple conversations from corresponding groups and/or subgroups, wherein the corresponding groups and/or subgroups include the same message participants.

22. The method of claim 1, further comprising:
displaying a consolidated view that shows messages of consolidated conversations from a plurality of groups and/or subgroups, and/or wherein displaying the messages of the conversations from the plurality of groups and/or subgroups as the consolidated view is in a chronology order, and/or marking and/or labelling the messages from the plurality of groups and/or subgroups in the consolidated view to indicate which group or subgroup that a corresponding message is originated from.

23. (canceled)

24. (canceled)

25. The method of claim 22, further comprising receiving a request to reply to at least one message of at least one conversation of the conversations from the plurality of groups and/or subgroups in the consolidated view.

26. The method of claim 1, further comprising configuring at least one status and associated functionality of a message with respect to relevant participants, subgroups and/or groups, wherein the at least one status is related to portability of the message with respect to the relevant participant(s), subgroup(s) and/or group(s).

27. (canceled)

28. (canceled)

29. (canceled)

30. The method of claim 26, further comprising determining the at least one status of the message based on a user input, and/or further comprising changing a state of at least one participant of the relevant participants, subgroups and/or groups.

31. (canceled)

32. (canceled)

33. (canceled)

34. The method of claim 1, further comprising:
adding one or more participants into a conversation associated with the messages; and
displaying one or more messages of the messages to the one or more added participants based on portability of each of the one or more messages.

35. (canceled)

36. (canceled)

37. (canceled)

38. The method of claim 1, wherein the messages include one or more applications, wherein at least one characteristic of the one or more applications is adaptable to a state of participants associated with the messages.

39. The method of claim 1, further comprising exchanging at least one of the messages with another messaging platform, wherein the another messaging platform implement a different method for messaging to the method of at least one of the preceding claims.

40. An electronic device, comprising: a computer system, wherein the computer is capable of communicating with a display, the computer system operating to:
display a group of message participants, the message participants being at least two participants or subgroups of participants, by displaying a participant representation for each participant or subgroups of participants in a participant interface area;
enable each participant representation to have one of a plurality of selectable states including one or more active states and one or more inactive states;
display, in a message interface area, the selected state of each participant representation and messages associated with each participant representation that are in a selected active state.

41. A computer program product configured to perform a method, comprising: at a computer system, wherein the computer system is capable of communicating with a display:
receiving a request to display a group of message participants, the message participants being at least two participants or subgroups of participants;
in response to receiving the request to display a group of message participants, displaying a participant representation for each participant or subgroups of participants in a participant interface area;
enabling each participant representation to have one of a plurality of selectable states including one or more active states and one or more inactive states;
displaying, in a message interface area, the selected state of each participant representation and messages associated with each participant or groups of participants that are in a selected active state.
